(19) United States
(12) Patent Application Publication
(10) Pub. No.: US 2008/0104001 A1
(43) Pub. Date: May 1, 2008

(54) ALGORITHM FOR ESTIMATION OF BINDING EQULIBRIA IN INCLUSION COMPLEXATION, HOST COMPOUNDS IDENTIFIED THEREBY AND COMPOSITIONS OF HOST COMPOUND AND PHARMACEUTICAL

(76) Inventor: James E. Kipp, Wauconda, IL (US)

Correspondence Address: BAXTER INTERNATIONAL INC., One Baxter Parkway, DF2-2W, Deerfield, IL, 60015-4633, US

(21) Appl. No.: 11/923,775

(22) Filed: Oct. 25, 2007

Related U.S. Application Data
(60) Provisional application No. 60/863,296, filed on Oct. 27, 2006.
(60) Provisional application No. 60/896,021, filed on May 15, 2007.

(51) Int. Cl. G06N 3/08

(52) U.S. Cl. 706/25

(57) ABSTRACT

The present invention discloses a neural network and associated algorithms for improving the identification of chemically useful compounds without having to test each investigated compound individually. The method utilizes a neural network and associated algorithms for estimating the ability to dissolve poorly water soluble molecules by formation of water-soluble inclusion (guest-host) complexes.

### CROSS-REFERENCE TO RELATED APPLICATIONS

This application claims the benefit of U.S. Provisional patent applications, Ser. No. 60/863,296 filed Oct. 27, 2006 and Ser. No. 60/896,021 filed May 15, 2007. The entire text of each of the aforementioned applications is incorporated herein by reference.

### BACKGROUND OF THE INVENTION

A computational method is disclosed herein for development of chemically useful agents in solution. A neural network and associated algorithms are disclosed and used for estimating the ability to dissolve poorly water soluble molecules by formation of water-soluble inclusion (guest-host) complexes. This method is an improvement over current methods of new product development, which often rely upon experimental trial and error, a time-consuming and costly process. The computational method embodied in this disclosure predicts specific material properties, the knowledge of which facilitates the design of useful aqueous solutions. The present neural network is “trained” on known binding constants for complexation of guest molecules with a host molecule such as cyclodextrin, and then used to predict the binding affinity of unknown compounds. Special applications include developing host compounds, such as specific cyclodextrin compounds, for preparing pharmaceutical compositions with advantageous coordination between properties of the host compound and the pharmaceutical.

### FIELD OF THE INVENTION

This invention pertains to the field of using computational methods in predictive chemistry. More particularly, the invention utilizes a neural network with associated algorithms, and the known properties of the molecules investigated, to optimize the prediction of physical properties for molecules of interest.

Traditional development of chemically useful solutions, such as those in the pharmaceutical art, have involved the arduous task of preparing test formulations in the laboratory and conducting stepwise experiments to elucidate pertinent chemical properties. These properties may include, but are not limited to, the following: solubility, water-oil partitioning, water-n-octanol partitioning, chemical stability, and physical stability, which are known to affect the ability to formulate a product. In the pharmaceutical industry, this slow, costly throughput is compounded by a lengthy drug discovery process, in which historically over 10,000 compounds must be individually tested and evaluated for every one that actually reaches the market (SCRIP, World Pharmaceutical News, Jan. 9, 1996, PJB Publications). Many times this failure can be attributed to water insolubility, which limits administration by a therapeutically effective route. This stark realization has driven many research organizations to shift their focus from traditional drug discovery to development of high throughput systems (HTP), or computational methods that leverage computer technology in the drug discovery and development process.

High-throughput systems and computational methods have been proposed in the area of drug discovery (Braunheim, U.S. Pat. No. 6,587,845, entitled “Method and Apparatus for Identification and Optimization of Bioactive Compounds Using a Neural Network”). This patent discloses the removal of a single value from a neural network type of training set, used as an “adjuster”. This value is left out during training and used to check if the neural network generalizes and is not overtrained. The neural network is trained until convergence, and the error between the actual and predicted output for the adjuster value is calculated. If the neural network predicts the adjuster value within 5%, that neural network's construction is saved. If the prediction is more than 5% off, a new network is chosen. However, the process for choosing a new network is not defined. In the '845 patent, this procedure is repeated until a construction is found that allows the neural network to predict a target to within 5%. The '845 patent further states that the “most common neural network construction is chosen as the final construction and that the final construction for this system is five hidden layer neurons, ten thousand iterations, learning rate equals 0.1 and the momentum term equals 0.9″.

The present disclosure is an improvement on this type of art, which does not provide a method for developing an entire network structure; that is: number of input parameters, number of hidden layers, number of neurons per layer, and so forth. There is thus a need, provided by the present disclosure, to develop a more complete network structure. There accordingly is a need for approaches that are oriented toward formulation development, and more particularly that are designed to estimate the ability to successfully formulate compositions of water-insoluble compounds by use of inclusion complexation and specific solubilizing agents.

Inclusion complexation is a process of rendering insoluble compounds more water soluble by enclosing the less water-soluble compound (guest molecule) within a cavity of the soluble “host” compound. Examples of such host compounds include cyclodextrins and their derivatives. Cyclodextrins comprised of six to eight glucopyranoside units assume a toroid structure, or truncated cone with the ends consisting of a large diameter rim and small diameter rim. Dissolved in water, the hydroxy groups on these rims are exposed to the aqueous environment. This configuration causes the interior of the cyclodextrin to be considerably less hydrophilic than the aqueous environment and thus able to interact with other hydrophobic molecules. The exterior is sufficiently hydrophilic to render cyclodextrins and their complexes more water soluble than the hydrophobic guests.

The formation of the inclusion compounds greatly modifies the physical and chemical properties of the guest molecule. Most importantly, the water solubility is enhanced. For this reason, cyclodextrins have attracted interest in many fields, and have led to the production of many chemically useful products. For example, a commercially available deodorizing solution of Proctor & Gamble is composed largely of a cyclodextrin in an aqueous medium. The “dryer sheets” that are used to release pleasant scents when laundry is heated are fabric or paper that is impregnated with dry, solid cyclodextrin microparticles that have been exposed to fragrances.

Cyclodextrins can also be used in environmental decontamination because they can effectively immobilize toxic compounds inside their rings. For example, trichloroethane, trichlorfon (an organophosphorus insecticide), and heavy metals, among many other compounds can form inclusion complexes with cyclodextrins. Cyclodextrins are employed in the production of cholesterol free food products, because the hydrophobic cholesterol molecule has the ideal shape to fit inside β-cyclodextrin. Other food applications include sequestration of volatile compounds and reduction of unwanted tastes and odors. Because volatile compounds, those with high vapor pressures, are often hydrophobic, cyclodextrins are complexed with fragrances and these substances can then be released at higher temperatures.

The solubility enhancement due to inclusion complexation of compounds with cyclodextrins can be especially useful in the pharmaceutical industry because the more soluble inclusion complexes are generally better able to penetrate body tissues, and derivatized cyclodextrins can serve as carriers to release biologically active compounds in-vivo. Furthermore, various drugs that have been nearly impossible to develop into solution formulations can be dissolved in aqueous solution by use of cyclodextrins. As demonstrated by example in the current disclosure, methods that can predict interaction of hydrophobes with cyclodextrins can be highly desirable, especially in the pharmaceutical context.

Useful derivatives of cyclodextrins have also been synthesized. 2-hydroxypropyl-β-cyclodextrin is more soluble than the parent compound, β-cyclodextrin. This further facilitates the preparation of solutions of drugs that would normally be too insoluble to formulate. Janssen Pharmaceutica L.P. (distributed by Ortho Biotech Products, L.P.) has used 2-hydroxypropyl-β-cyclodextrin to formulate a solution product of the antifungal agent itraconazole for injection (Sporanox IV). By itself, the aqueous solubility of itraconazole is extremely low (less than 0.1 microgram/mL). Another useful cyclodextrin derivative is sulfobutylether 7-β-cyclodextrin, also known as Captisol® (Cydex, Inc.). This molecule also has a much higher solubility than the underivatized molecule, β-cyclodextrin. Ziprasidone (Geodon® mesylate, by Pfizer) and voraconazole (Vfend®, by Pfizer) have been successfully formulated by using this cyclodextrin derivative, and are presently marketed.

In aqueous solution, a poorly soluble compound avoids interaction with water and prefers to reside within the hydrophobic cavity of the cyclodextrin. The combination of the two molecules behaves as a single solution species, or complex, that is in equilibrium with the dissociated guest and host molecules, this equilibrium defined by an equilibrium constant. In the context of inclusion complexation, the equilibrium constant is termed a binding constant, and at times the terms association constant, formation constant, or stability constant are applied.

An artificial neural network (ANN), commonly referred to as a neural network, is an information-processing method that mimics, to some degree, the functioning of neurons in biological systems. They are generalized models of human cognition that are based on the following assumptions: (1) processing operations occur at a series of nodes (“neurons”) that form network layers, (2) processed data are passed between layers wherein all or a portion of the neurons from one layer converge at one neuron of another layer, (3) data passed from each neuron to the next are multiplied by a weighting factor, and (4) each neuron that receives the weighted sum from neurons in the previous layer applies a transfer or activation function to this sum. In practical terms, neural networks are non-linear statistical modeling tools that can be used to model complex relationships between inputs and outputs, or to find data patterns. They are trainable systems that “learn” to solve complex problems from a set of examples (“training set”), and generalize the “acquired knowledge” to solve complex problems.

### SUMMARY OF THE DISCLOSURE

Briefly stated, the disclosure herein provides a neural network and novel algorithms for optimizing the network structure in order to predict the propensity of at least one molecule of interest that is poorly soluble in water to form inclusion complexes in an aqueous environment. This methodology is applicable to a wide variety of compounds of interest using the same training protocols and the same molecular descriptors, or portions thereof as discussed herein. According to an exemplary embodiment, a computational method and associated algorithms for optimizing the structure of a neural network have been developed to predict binding between organic molecules and inclusion host compounds, preferably cyclodextrins and their derivatives.

Aspects, objects and advantages of the present disclosure, including the various features used in various combinations, will be understood from the following description according to preferred embodiments, taken in conjunction with the drawings in which certain specific features are shown.

### BRIEF DESCRIPTION OF THE DRAWINGS

FIG. 1 provides the chemical structure of beta-cyclodextrin;

FIG. 2 is a diagram of a simple neural network with one hidden layer;

FIG. 3 is an ellipsoidal representation of a molecule, illustrating orthogonal inertial axes;

FIG. 4 is a correlation analysis and descriptor set size reduction plot;

FIG. 5 is a selection of number of hidden layer neurons and correlation plot;

FIG. 6 is a correlation plot of training set using reduced parameter model (17 molecular descriptors, 11 hidden layer neurons);

FIG. 7 is a correlation plot of validation data (n=31);

FIG. 8 is a correlation plot of pooled data set (training+validation sets, n=131);

FIG. 9 is a correlation plot of cross-validation set (n=16); and

FIG. 10 is a correlation plot between two ranking methods).

### DESCRIPTION OF PREFERRED EMBODIMENTS

The present disclosure relates to neural networks and associated algorithms for improving the identification of chemically useful compounds without having to experimentally test each investigated compound. As is known in the art, neural networks adapt to predict behavior that is a complex, nonlinear function with many variables. Unlike a regression model, in which a well-defined parametric equation is fitted to data, neural networks can a priori model data in which no function is known beforehand, or in which no practical, simple function can be derived. This feature makes the technique valuable in decision making because it requires no assumptions about the mathematical form of the model. In the current disclosure an illustrated input is a set of molecular descriptors, and the output is the binding constant for association of the molecule with an inclusion host molecule, preferably a cyclodextrin.

As is known in the art, a computational neural network is a computer algorithm which, during its training process, can learn features of input patterns and associate these with an output. Neural networks thus learn to approximate relationships between input/output pairs. After the learning phase, a well-trained network should be able to predict an output for a pattern not in the training set.

In the current disclosure, the neural network is trained with sets of properties of guest molecules that can interact with a host compound such as beta-cyclodextrin, until the neural network can associate an output with every set of parameters that describe the molecular properties of a guest molecule in the training set. The output is the logarithm of the binding constant that defines the complexation equilibrium. The network is then used to predict the logarithmic binding constants for unknown molecules. The neural network thus creates a computational structure that defines a complex, nonlinear relationship between calculated physical aspects of a molecule and chemical behavior of the bulk material.

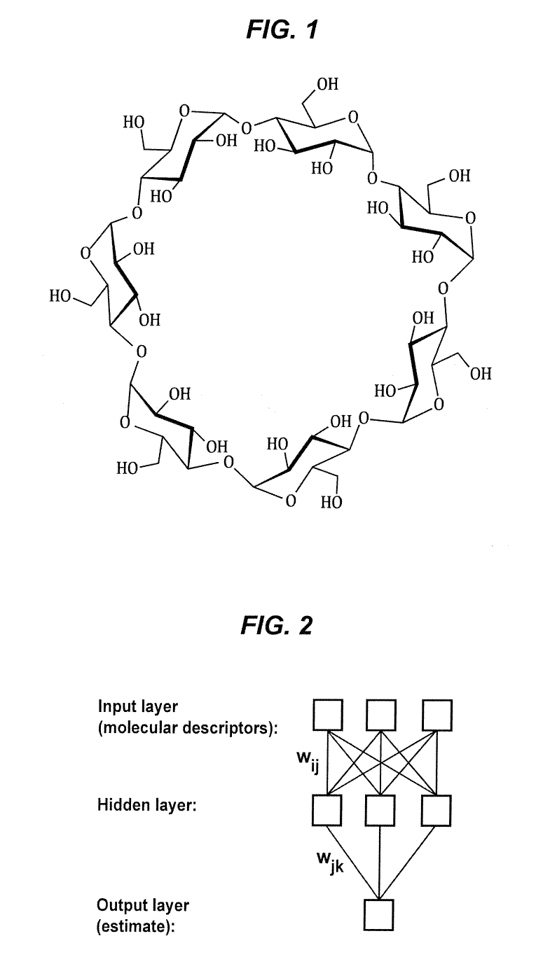

The present disclosure is especially suitable to facilitate inclusion complexation and identify host compounds. Typical host compounds are cyclodextrins. An example of a cyclodextrin is β-cyclodextrin (FIG. 1). Cyclodextrins (sometimes called cycloamyloses) are cyclic oligosaccharides, composed of five or more α-D-glucopyranoside units linked 1->4. The largest known cyclodextrins incorporate more than 150 glucopyranoside units into a cyclic oligosaccharide. The most common cyclodextrins contain concatenated glucose monomers ranging from six to eight units in a ring, and the size of the ring is denoted by the following prefixes:
α-cyclodextrin=six D-glucose molecules in a ring;
β-cyclodextrin=seven D-glucose molecules in a ring;
γ-cyclodextrin=eight D-glucose molecules in a ring.

The above cyclodextrins, other cyclodextrins of varying ring size, and their derivatives, are illustrative of compounds used in inclusion complexation of this disclosure.

After the neural network is “trained” with parametric data for molecules, each having known chemical behavior, the network has “learned” the relationships that correlate these data to chemical behavior for that type of compound. The current disclosure also relates associated algorithms that facilitate construction of a neural network that uses to the fullest advantage these learned relationships to generate estimates of chemical behavior that can be applied in the design of chemically useful molecules and/or formulations of these molecules.

Computational neural networks are usually composed of many simple units operating in parallel. These units and the aspects of their interaction are inspired by biological systems. The function of the network is largely determined by the interactions between units. An artificial neural network consists of a number of “neurons” or “hidden units” that receive data from the outside, process the data, and output a signal. A network with one input layer (three input values), one output layer (one estimate), and one hidden layer (three hidden neurons), is shown in FIG. 2. A “neuron” is essentially a regression equation with a non-linear output. When more than one neuron is used, highly complex non-linear models can be fitted.

Networks learn by adjusting weighting values for connections between neurons (nodes) that define the importance of each input to that neuron (node). (Fausett, L. Fundamentals of the Neural Networks; Prentice Hall: New Jersey, 1994). The neural network in the current disclosure is a feed-forward type with error back-propagation. Feed-forward neural networks with error back-propagation, of the type disclosed herein, are trained by entering data into an “input layer”, shown in FIG. 2, which is the first layer in a hierarchy that makes up the network. Data are processed by that layer and “fed forward” to the next layer in the hierarchy.

In this disclosure, the input layer consists of molecular attributes (molecular descriptors), among which include quantum mechanical properties, such as the energy of the highest-occupied molecular orbital (HOMO), of molecules for which the binding constants are known. The predictive power of the system is gained by “training” the neural network using the known binding constants of at least one training molecule—the “training set”. When the neural network is able to accurately predict the binding constants for the training set, then the same neural network can be used to accurately determine binding constants, and hence binding equilibria, of unknown molecules. Knowledge of these equilibria is advantageous in the prediction of water solubility.

A back-propagation neural network has multiple layers comprised of an input layer, at least one hidden layer, and an output layer (see FIG. 2). The strength of the back-propagation neural network is the ability to impart complex non-linearity by variation of weights with the hidden layers of the network. There may be one or more hidden layers, each with several neurons per layer, depending on the complexity of the problem. The neurons comprising the input layer consist of input data. Each node in a hidden layer receives a weighted sum of all of the inputs from the preceding layer. In FIG. 2, wij is a weighting factor that connects the first neuron from the input layer (ith neuron within the layer), to the hidden layer, jth neuron. In FIG. 2, i=1 and j=1. The resulting weighted sums accumulated in each neuron of the hidden layer become the inputs for the next layer (kth neuron in that layer) in the network. In FIG. 2, k=1. These weights (wij, and wjk) can be expressed in matrix form as the product of an input vector and a weight vector. The weighted sum determined at a given node (neuron) is fed into a nonlinear function, the activation or transfer function, which determines the final output from that neuron to a neuron in the next layer, hidden or output. In the back-propagation network, a final output (estimated value in the output layer), is compared with the known data value.

In the current disclosure, the known output is the logarithm of the binding constant, Log β, where β is the binding constant. The difference between network output and known value is calculated and used to mathematically adjust all of the weighting factors (back-propagation) in the previous layer. One algorithm for adjusting the weighting factors is known as the Delta rule (see Fausett, p 86). The same mathematical procedure is successively applied to previous layers, thereby adjusting weights for each layer. This operation sequence can be applied through multiple iterations until a desired outcome (for example, minimizing the absolute value of the difference between output and known value) is realized.

For the present disclosure, the input layer of the back-propagation network comprises molecular descriptors—calculated attributes of a given molecule. These calculated attributes may be those calculated by application of a molecular modeling program (such as HyperChem, by Hypercube, Inc., Gainesville Fla.). Another example of a molecular modeling program is Spartan for Windows '06 (Wavefunction Inc., Irvine, Calif.). Application of this type of software affords parameters (molecular descriptors) that can be used as input to the network. These descriptors may be the result of quantum mechanical calculations such as self-consistent field calculations.

Self-consistent field methods consist of ab initio (Hartree-Fock) methods, semi-empirical methods such as Linear Combination of Atomic Orbitals (LCAO) methods, or density function algorithms such as the Becke method (Becke, A. D. A new mixing of Hartree-Fock and Local Density-Functional Theories, J. Chem. Phys. 98, 1372-1377 (1993)). The descriptors can also comprise molecular parameters that are calculated by group-contribution methods in which a molecular property is a function of the some or all of the structural groups (e.g., ester group, ketone, alcohol, etc) within the molecule. Molecular descriptors may also comprise directly observable aspects of the molecule that can be noted by visual inspection of its structure. For example, the number of hydrogen-bond acceptors (non-bonded electron pairs on N and O) and hydrogen-bond donors (hydrogen atoms connected to N or O) may be determined by examining molecular structure. The number of atoms of each hybridization type (e.g., sp3, sp2, sp) is also an example of an observable, non-calculated property.

Descriptors may be calculated by using molecular mechanics algorithms that treat a molecule as an array of interconnected masses, each mass representing an atom, and in which bonds between atoms are approximated as springs with restoring forces. The properties of molecules can then be estimated by application of simple Newtonian mechanics determination of interatomic forces, and molecular motions or trajectories, derived by calculations of velocity and acceleration for each mass in the system.

Descriptors also may be calculated from mass distribution in the optimized molecular geometry determined by quantum-mechanical (ab initio, semi-empirical, or density functional) methods, by molecular mechanics methods, or by a combination of these methods. For example, if the distribution of mass is calculated, then moments of inertia may be determined from this distribution.

The moment of inertia of a solid body with density ρ(r) with respect to a given axis is defined by the volume integral according to the following Equation (1):
I=∫ρ(r)r_{⊥}²dV,
where r⊥ is the perpendicular distance from the axis of rotation. This can be broken into components according to the following Equation (2):
Iⱼₖ=Σmᵢ(rᵢ²δⱼₖ−xᵢⱼxᵢₖ)
for a discrete distribution of mass, where r is the distance to a point (not the perpendicular distance) and δjk is the Kronecker delta, wherein δjk=0, for j≠k, and δjk=1, for j=k.

For a continuous distribution, Equation 2 becomes an integral equation, integrated over the molecular volume, according to Equation (3):

$$I = {\int }_{V}^{} ρ ( r ) ( {r}^{2} {δ}_{jk} - {x}_{j} {x}_{k} ) ⅆ V ,$$

where dV is a volume element.

Expanding Equation (3) in terms of Cartesian axes affords matrix Equation (4):

$$I = {\int }_{V}^{} ρ ( x , y , x ) [ \begin{matrix}{y}^{2} + {z}^{2} & - xy & - xz \\ - xy & {z}^{2} + {x}^{2} & - yz \\ - xz & - yz & {x}^{2} + {y}^{2}\end{matrix} ] ⅆ x ⅆ y ⅆ z$$

The moment of inertia tensor, I, is related to the angular momentum vector L by Equation (5):
L=Iω
where ω is the angular velocity vector.

Equation 5 can thus be recast in matrix form, as in Equation 6. The principal moments are given by the entries in the diagonalized moment of inertia matrix. In the principal axes frame, the moments are also sometimes denoted Ixx, Iyy, and Izz. The principal axes of a rotating body are defined by finding values of I such that Equation (6) is as follows:

$$L = [ \begin{matrix}{L}_{x} \\ {L}_{y} \\ {L}_{z}\end{matrix} ] = [ \begin{matrix}{I}_{11} & {I}_{12} & {I}_{13} \\ {I}_{21} & {I}_{22} & {I}_{23} \\ {I}_{31} & {I}_{32} & {I}_{33}\end{matrix} ] [ \begin{matrix}{ω}_{x} \\ {ω}_{y} \\ {ω}_{z}\end{matrix} ] = I [ \begin{matrix}{ω}_{x} \\ {ω}_{y} \\ {ω}_{z}\end{matrix} ] .$$

Elimination of right side the above matrix equation,

$$I [ \begin{matrix}{ω}_{x} \\ {ω}_{y} \\ {ω}_{z}\end{matrix} ] ,$$

by subtraction from both sides yields Equation (7), namely:

$$[ \begin{matrix}{I}_{11} - I & {I}_{12} & {I}_{13} \\ {I}_{21} & {I}_{22} - I & {I}_{23} \\ {I}_{31} & {I}_{32} & {I}_{33} - I\end{matrix} ] [ \begin{matrix}{ω}_{x} \\ {ω}_{y} \\ {ω}_{z}\end{matrix} ] = [ \begin{matrix}0 \\ 0 \\ 0\end{matrix} ] .$$

Equation 7 is the matrix construct of an eigenvalue equation. If one approximates a small molecule as an equivalent solid ellipsoid with uniform density, then the ellipsoid has the following inertial components along minor and major axes, according to set of Equations (8):
I₁=1/5M(x₂²+x₃²)
I₂=1/5M(x₁²+x₃²)
I₃=1/5M(x₁²+x₂²)
where (I₁<I₂<I₃) and in which x₁ is an effective ellipsoidal diameter along the major inertial axis, and X₂ and X₃ are ellipsoidal diameters along the minor axes, in decreasing order of magnitude.

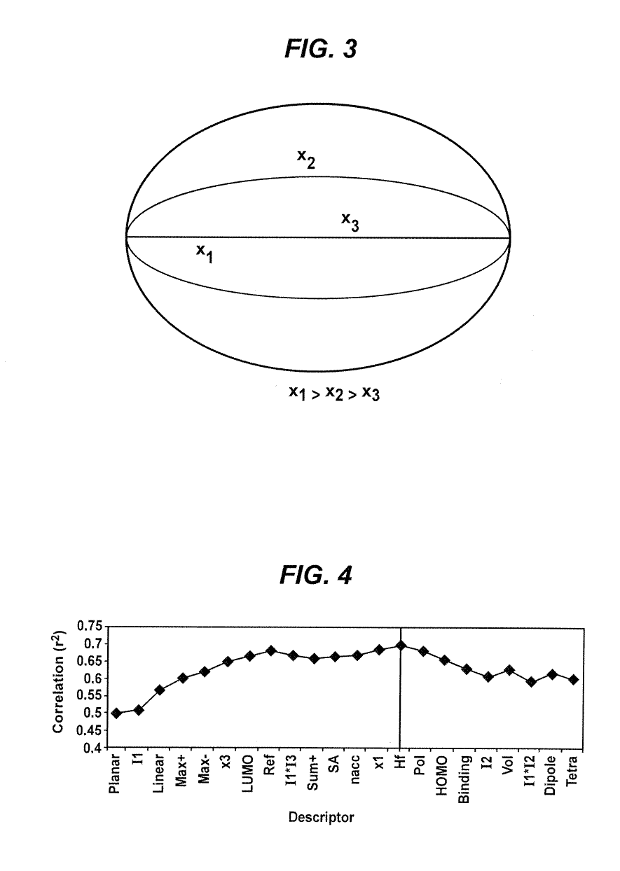

Among the novel aspects of the present disclosure is the utilization of molecular moments of inertia as parameters that are entered into the input layer of the network. I₁, I₂, I₃ and their cross products, I₁I₂, I₁I₃, and I₂I₃, are highly influenced by the size or topology (shape) of the molecule. From the moments of inertia, the major (x₁) and minor diameters (x₂ and x₃) of an ellipsoid that has moments of inertia that are equivalent to those of the actual molecule (see FIG. 3 can be calculated). Solving the above system of Equations (8) provides the following set of Equations (9):

$$\begin{matrix}{x}_{1} = \sqrt{\frac{5 ( {x}_{2}^{2} + {x}_{3}^{2} )}{2 M}} \\ {x}_{2} = \sqrt{\frac{5 ( {x}_{1}^{2} + {x}_{3}^{2} )}{2 M}} \\ {x}_{3} = \sqrt{\frac{5 ( {x}_{1}^{2} + {x}_{2}^{2} )}{2 M}}\end{matrix}$$

Molecular inertial moments correspond to rotation about respective inertial axes (see FIG. 3). I₃ (largest moment) is related to the torque needed to rotate the molecule about its shortest inertial diameter, X₃. This parameter is most closely related to the ellipsoidicity (elongation) of the molecule along its major ellipsoidal diameter (x₁). The smallest moment of inertia, I₁, resulting from rotation about the principal (major) diameter, conveys little information about ellipsoidicity. The I₂ and I₃ descriptors and equivalent ellipsoidal diameters are highly sensitive to molecular topology (size and shape). This topology or shape in turn affects the propensity of the molecule to conform to the hydrophobic cavity of the inclusion host (e.g., cyclodextrin).

The neural networks provided herein are thus useful in modeling chemical interactions that are non-covalent in nature, and mediated by molecular topology and the electrostatic forces between the guest molecule and host. Given known properties of a set of molecules (“training set”), the neural networks provided herein, and the associated algorithms, are accurate predictors of interaction between the guest molecule and host. In this way, the neural networks described herein are able to determine hydrophobicity and molecular topologies that will maximize interaction with the host molecule, enhance solubility, and thereby facilitate rapid solution product development.

In order to train a neural network, the following network parameters are used traditionally: (1) number of hidden layer neurons, (2) number of hidden layers, (3) the learning rate, (4) momentum, (5) the number of training iterations, and (6) parameters associated with the transfer or activation function. A method of assessing whether a network is well trained is to minimize the training set estimation error. Typically, this can be calculated by taking the absolute value of the difference between the known data value for a molecule (experimentally determined log(binding constant)), and the output from the network. The estimation error for the training set can be expressed in several ways. In particular, the absolute value of the difference summed over all the molecules in the training set, is one method. Another way to express error is to sum the squared differences. Yet another method entails minimizing the correlation value for a plot of the predicted versus measured values. As training progresses the prediction error will decrease.

Overtraining may occur when the number of training iterations is too large, the network has too many hidden layer neurons, too many hidden layers, has too large of a learning rate, or too small of a momentum constant. Overtraining may be detected by applying the trained network to at least one pattern not in the training set. In this manner, one can determine whether the network can generalize estimates deduced from the information contained in the input/output pairs of the training set, and predict properties of a new molecule not within the original training set.

Meaningful input parameters (in this case molecular descriptors) must also be entered into the input layer of the network in order to provide accurate and reliable predictions. Therefore, a process for selecting the best molecular descriptors is desirable. A unique feature of this disclosure is that it provides an associated algorithm for choosing the best parameters that lead to networks that afford accurate predictions without overtraining, and is thus able to generalize well to other data sets. Another unique feature of this disclosure is that another associated algorithm optimizes the number of hidden layer neurons to build a network that best predicts values in an external (validation) set.

In this disclosure, parameter and hidden layer optimization is carried out by a parameter “holdout” process. First, the entire parameter pool (size p) is used in the model and applied to a training set of molecules with known binding constants. A set of outputs (estimates of binding constants for the training set) is obtained by varying the nodal weights, and optionally the learning rate and momentum. The weights are corrected by back-propagation, using the delta rule for example, and the new weights are applied in the next iteration. Iterative modification of the weights, and optionally the learning rate and momentum is made to the network and training ceases when a convergence criterion is reached. That is, further iterations produce output changes that are insignificant, and in which the predicted value lies within a tolerance interval about the known data value.

Unlike traditional methods of network optimization, with the present approach the network that is afforded from training using p descriptors is immediately applied to a second data set (“validation set”), a set of molecules with known binding constants, and the a correlation (squared correlation constant, r2), between measured values and network output (estimates) is made. This squared correlation is identified as c(p), where p is the number of network parameters (molecular descriptors) used in training the model. One arbitrary parameter is then removed from the parameter pool, providing a set with p—1 parameters. The new network with p−1 parameters is applied to the training set, and again the trained network with p−1 parameters is applied to the validation set, and a squared correlation, c(p−1) is obtained. The parameter that was removed is then replaced, and a different parameter is removed. This process is repeated until all p parameters have been individually removed to provide p sets with p−1 parameters, and a squared correlation value has been obtained for each removed parameter.

The parameter whose removal from the parameter set of p parameters produces the highest squared correlation value is permanently removed from the original set. The entire parameter selection and removal process is then repeated on the set of p−1 parameters, and continued over many iterations until a parameter set with p−k parameters is reached wherein the squared correlation is maximized. Here k represents the number of parameters removed from the starting parameter pool.

Using this optimized network with p−k parameters, the number of hidden layer neurons is varied, and after each change the network is trained on the training set and applied to the validation set. The number of hidden layer neurons that affords the highest squared correlation in the validation set is chosen as the final, optimized model. Likewise, other network parameters (for example, the number of hidden layers, and the activation function or bias) can be optimized separately or in combination by systematic variation to locate the set of network parameters that provide the lowest error or highest correlation in the validation set.

This optimization can also be conducted using any non-parametric optimization method such as the sequential Simplex method of Nelder and Mead (Nelder, J. A. and Mead, R. “A Simplex Method for Function Minimization.” Comput. J. 1965, 7, 308-313). The sequential Simplex method is a non-parametric optimization method that works well for stochastic problems, those in which the functional form of the problem may be unknown. It is based on evaluating inputs assigned to the vertices of a polygon (the “simplex”) in n-dimensional parameter space, and then iteratively shrinking the simplex as better points are found until a desired limit is reached. For example, the number of hidden neurons per layer, number of hidden layers, and parameters of the activation function might be the vertices of the Simplex polygon. Momentum and learning rate affect the speed at which learning occurs, and are also included as possible network parameters to be optimized.

The model optimization method embodied in this disclosure provides more than using a single value removal as an adjuster. A correlation approach is used, and a set of values are excluded. It will be appreciated that the present approach provides a method for developing an entire neural network structure. Accomplishing same includes application of the parameter holdout method described herein, use of a validation set with more than one data value, and optimization of the number of hidden layer neurons, and by inference other parameters as well. Quantum mechanical and molecular mechanical computations can provide inputs for training a neural network. As part of an exemplary description of a use of the present disclosure, molecular descriptors (input parameters for each member of the training set) were created in the following way. Using molecular mechanics, conformational analysis (Merck Molecular Force Field, in Spartan for Windows '04, Wavefunction Inc., Irvine, Calif.) was carried out on each molecule of the training set to select a molecular conformation for each member that lay as close as possible to a global energy minimum. The geometry of each molecule was refined by using a semi-empirical molecular orbital method, AM1 (HyperChem version 7.52, Hypercube, Gainesville, Fla.).

Self-consistent field (SCF) calculation (AM1) of orbital wave functions provided parameters for each molecule that described its electronic distribution, atomic charges, orbital energies, core energy, electronic energy, atom energy, and binding energy.

In a molecular orbital calculation, it is very convenient to distinguish the low-energy atomic orbitals that do not overlap with those on adjacent atoms, and orbitals that do overlap and are involved in chemical bonding. Core energy is defined as that of the non-valence electrons, those that are lowest in energy and do not participate significantly in forming chemical bonds. Their energy is comprised of a linear combination of inner atomic orbitals. The atom energy is the sum of energies of the individual atoms that comprise the molecule. Electronic energy is the sum of the kinetic energy of all the electrons, their electrostatic interactions with nuclei, and interelectronic repulsion. Binding energy is the electronic energy relative to isolated atoms: that is, it is the difference between electronic energy and atom energy. The molecular heat of formation can also be estimated by subtracting the heats of formation of the various elements that comprise the molecule from its SCF electronic energy. From the orbital wave functions, electron distribution can also be calculated, as well as chemical parameters that result from that distribution. In this disclosure, dipole moment and atomic charges are used to describe electronic distribution, or polarity. Dipole moment, which is one measure of charge separation, is defined as the sum of point charges from a reference origin at the molecular center, where ri is the distance from that center to point charge, qi, according to the following Equation (10):
μ=Σqᵢrᵢ

In quantum mechanics, dipole moment (μ) is calculated from the wave function by use of the dipole moment operator, \hat{μ} by the Equation (11):

$$μ = \frac{\int {φ}_{i}^{*} \hat{μ} {φ}_{i} ⅆ v}{\int {φ}_{i}^{*} {φ}_{i} ⅆ v} , where \hat{μ} = {\sum }_{i} ( - {r}_{i} ) + {\sum }_{A} {Z}_{A} {R}_{A} ,$$

and rᵢ is defined above, Z_{A} is the charge of the nuclear core and R_{A} is the distance between molecular origin and nucleus A. Here φi is the molecular orbital wave function and φi* is its complex conjugate. Atomic charges can also be calculated using molecular orbital theory. Several methods may be used in this calculation. A typical method, as employed herein, is the Mulliken population analysis (Hehre W J, A Guide to Molecular Mechanics and Quantum Chemical Calculations, Wavefunction, Irvine Calif., 2003, p 436). Values obtained by this method are dependent on the type of quantum mechanical calculation method that is employed.

Group contribution methods can provide inputs for training a neural network. In a group-contribution method, the molecule is split into segments, each segment contributing to a physical or chemical property of the entire molecule. The sum of these contributions is an estimate of the property. As part of an exemplary description of a use of the present disclosure, group contribution methods are applied to calculate the following parameters (molecular descriptors): Log P (octanol-water partition coefficient), molar refractivity, molar polarizability, molecular surface area, and molecular volume. Log P, the logarithm of the octanol-water partition coefficient, is a measure of the solubility in a non-polar solvent, n-octanol, versus water. It therefore reflects the hydrophobicity, which is that physical property of a molecule that makes the molecule avoid interacting with water.

Hydrophobic molecules tend to be nonpolar and thus prefer nonpolar solvents, those that exhibit negligible or very small charge separations, either within a chemical bond, or across the whole molecule (dipole moment). In this example, Log P is calculated by using the method implemented within HyperChem, the Ghose-Crippen method (Ghose, Pritchett and Crippen, J. Comp. Chem., 1988, 9, 80, and Viswanadhan V N, Ghose A K, Revankar, G N, Robins, R K, J. Chem. Inf. Comput. Sci., 1989, 29, 163). Molar refractivity is another measure of hydrophobicity and is estimated in HyperChem by a method nearly identical to that for Log P (Ghose A K, Crippen, GM I. Chem. Inf. Comput. Sci., 1987, 27, 21). Molar polarizability is a parameter that reflects the work needed to induce an electronic charge separation (e.g., dipole moment) by application of an external electric field. It is estimated within the program HyperChem by using the additivity method of Miller (Miller K J J. Am. Chem. Soc., 112, 1990, 8533).

The model of the present disclosure uses beta-cyclodextrin as a surrogate for predicting complexation with derivations of beta-cyclodextrin, such as capistol (sulfobutylether 7-beta cyclodextrin) and 2-hydrocypropyl beta-cyclodextrin. As examples of the present technology, Table 1 provides a list of drugs that are pharmaceutical candidates according to the neural network model hereof.

TABLE 1

| | | Predicted |
|---|---|---|
| | Estimated | concentration |
| | solubility | (mg/mL) @ 10% |
| Compound | (mg/mL) | beta-cyclodextrin |
| Nimodipine | 9.20E−01 | 8.82 |
| Propafenone | 6.23E−02 | 34.06 |
| Dronabinol | 3.06E−01 | 29.54 |
| Carbamazepine | 1.13E−01 | 13.78 |
| Dapsone | 4.32E−02 | 15.28 |
| beclomethasone dipropionate | 7.02E−02 | 51.54 |
| Diflomotecan | 7.12E−03 | 6.94 |
| Zileuton | 4.78E−01 | 20.51 |
| Iometopane | 3.05E−02 | 24.29 |
| Nalfuratine | 3.22E−01 | 14.77 |
| Edaravone | 4.83E−01 | 7.61 |
| Pleconaril | 7.42E−04 | 37.82 |
| Albaconazole | 1.10E−01 | 42.37 |
| Parecoxib | 2.38E−01 | 20.98 |
| arundic acid | 1.34E−01 | 15.92 |
| Indinavir | 5.35E−03 | 61.35 |
| fluticasone 17-propionate | 3.97E−02 | 44.47 |
| Fluticasone | 1.92E−02 | 25.26 |
| Flumethasone | 9.19E−02 | 14.93 |
| flumethasone 21-pivalate | 1.48E−02 | 47.74 |
| betamethasone dipropionate | 1.40E−01 | 50.37 |
| Fluorometholone | 4.53E−02 | 13.77 |
| Resveratrol | 9.57E−03 | 10.03 |
| Dantrolene | 2.31E−02 | 28.21 |
| Nicardipine | 1.54E−01 | 42.46 |
| medroxyprogesterone acetate | 8.34E−03 | 35.13 |
| Pantoprazole | 5.05E−02 | 31.86 |
| Ceftobiprol | 2.32E+01 | 53.46 |
| Quetiapine | 5.43E−02 | 31.21 |
| Flurazepam | 7.69E−01 | 31.50 |
| Fluoxetine | 3.18E−01 | 5.07 |
| Fluvoxamine | 2.04E−01 | 9.05 |
| Nortriptyline | 5.32E−01 | 11.15 |
| Sertraline | 2.82E−03 | 11.96 |
| Methotrexate | 3.28E−01 | 44.96 |
| mycophenolate mofetil | 5.59E−01 | 34.83 |
| Ondansetron | 8.95E−02 | 12.73 |
| Propanidid | 1.98E−02 | 10.69 |
| betulinic acid | 7.80E−04 | 22.93 |
| Fluasterone | 1.77E−02 | 27.37 |
| Fenofibrate | 3.79E−02 | 35.29 |
| Carabersat | 2.56E−01 | 7.02 |
| chlormadinone acetate | 7.39E−03 | 10.77 |
| Ganciclovir | 5.00E+01 | 23.39 |
| Triamcinolone | 1.12E−01 | 8.76 |
| 5-(3-methyl-2-butenyl)-5- | 8.05E−01 | 17.31 |
| ethylbarbituric acid | | |
| 5-methyl-5-(3-methyl-2- | 8.97E−01 | 9.72 |
| butenyl)barbituric acid | | |
| Estrone | 1.05E−02 | 18.88 |
| Dibucaine | 8.40E−02 | 27.78 |
| Ketoprofen | 4.83E−02 | 7.08 |
| 5,5-diethyl-2-thiobarbituric acid | 1.41E+00 | 15.91 |
| 5,5-dipropylbarbituric-acid | 2.29E+00 | 18.38 |
| Reposal | 5.87E−01 | 17.42 |
| 5-ethyl-5-octylbarbituric acid | 4.92E−02 | 23.74 |
| Dexamethasone | 8.33E−02 | 23.52 |
| betamethasone-17-valerate | 2.96E−02 | 5.39 |
| Norethindrone | 1.60E−02 | 14.87 |
| 5-ethyl-5-pentylbarbituric acid | 9.57E−01 | 18.64 |
| 5-allyl-5-butylbarbituric acid | 1.02E+00 | 14.83 |
| Testosterone | 4.48E−02 | 22.64 |
| hydrocortisone-21-acetate | 1.53E−02 | 10.93 |
| Heptabarbital | 4.51E−01 | 18.86 |
| Phenytoin | 1.46E−01 | 11.18 |
| Pentazocine | 3.70E−02 | 8.51 |
| 17a-methyltestosterone | 3.44E−02 | 24.86 |
| Thiopropazate | 1.37E−02 | 44.60 |
| testosterone acetate | 1.02E−02 | 19.89 |
| Tetracycline | 4.94E−01 | 25.15 |
| 5-methyl-2-thiouracil | 2.42E+00 | 7.66 |
| Ibuprofen | 7.65E−02 | 16.31 |
| Hydrocortisone | 1.45E−01 | 21.37 |
| Thiopental | 2.18E−01 | 14.40 |
| 5-ethyl-5-nonylbarbituric acid | 1.13E−02 | 27.64 |
| Phenacetin | 8.97E−01 | 10.10 |
| cycloheptyl-5-spirobarbituric acid | 1.21E+00 | 20.05 |
| Allopurinol | 1.59E+01 | 9.37 |
| Methylprednisolone | 7.70E−02 | 12.05 |
| 5-allyl-5-phenylbarbituric acid | 4.37E−01 | 15.62 |
| Naproxen | 2.34E−02 | 6.15 |
| 5-t-butyl-5-(3-methyl-2- | 2.13E−01 | 15.41 |
| butenyl)barbituric acid | | |
| Butamben | 2.27E−01 | 7.78 |
| cyclopentyl-5-spirobarbituric acid | 3.45E+00 | 17.29 |
| Prednisolone | 9.28E−02 | 16.56 |
| Corticosterone | 7.94E−02 | 10.92 |
| Trimazosin | 3.35E−01 | 43.54 |
| 5-ethyl-5-(1- | 9.62E−01 | 20.83 |
| methylbutyl)barbituric acid | | |
| Indoprofen | 6.45E−03 | 7.71 |
| Z-nifuroxime | 4.12E+00 | 8.52 |
| 5-ethyl-5-(3- | 7.62E−01 | 19.92 |
| methylbutyl)barbituric acid | | |
| 2-thiouracil | 4.02E+00 | 5.23 |
| Vinbarbital | 1.41E+00 | 13.51 |
| Butallylonal | 8.40E−01 | 28.23 |
| Stanolone | 2.35E−02 | 14.87 |
| 5-methyl-5-phenylbarbituric acid | 7.65E−01 | 16.43 |
| norethindrone acetate | 4.27E−03 | 8.38 |
| prasterone acetate | 4.40E−03 | 17.05 |
| Progesterone | 5.04E−03 | 8.87 |
| Betamethasone | 7.09E−02 | 22.09 |
| Prasterone | 2.04E−02 | 5.61 |
| Danazol | 8.49E−03 | 7.36 |
| Dihydroequilin | 1.14E−02 | 6.68 |
| cyclooctyl-5-spirobarbituric acid | 6.98E−01 | 20.29 |
| Hexethal | 2.15E−01 | 19.15 |
| Cyclobarbital | 1.03E+00 | 19.43 |
| 5,5-diailylbarbituric acid | 1.31E+00 | 13.41 |
| Cortisone | 3.90E−02 | 7.76 |
| Warfarin | 2.45E−02 | 12.40 |
| Risocaine | 6.18E−01 | 12.29 |
| Estriol | 1.49E−02 | 18.99 |
| Alloxantin | 3.79E+00 | 16.31 |
| Secobarbital | 6.17E−01 | 18.17 |
| deoxycorticosterone acetate | 4.12E−03 | 6.37 |
| 5-ethyl-5-(3-methylbut-2- | 7.99E−01 | 17.32 |
| enyl)barbituric acid | | |
| Phenobarbital | 7.09E−01 | 19.96 |
| dexamethasone-21-acetate | 1.70E−02 | 6.61 |
| 17a-hydroxyprogesterone | 1.95E−02 | 17.73 |
| cyclohexyl-5-spirobarbituric acid | 2.14E+00 | 19.02 |
| Sulindac | 7.68E−03 | 18.94 |
| ethinyl estradiol | 1.34E−02 | 7.59 |
| cortisone acetate | 1.33E−02 | 7.92 |
| Estradiol | 1.29E−02 | 5.36 |
| 5-(3-methyl-2-butenyl)-5- | 3.66E−01 | 10.84 |
| isopropyibarbituric acid | | |
| Androstanedione | 1.35E−02 | 13.68 |
| Demeclocycline | 4.88E−01 | 5.03 |

Additional examples regarding practice and use of the principles of this disclosure are as follows.

### Example

Starting with one hidden layer with 10 neurons, a back-propagation network (Ward Systems Software, NeuroShell) was trained on the descriptor sets of 100 organic non-electrolytes with published stability constants (Connors, 1995). The compounds included in the training set are shown in Table 2.

TABLE 2
Training set (100 compounds)

| | Log |
|---|---|
| Compound | K(1:1) |
| metharbital | 2.36 |
| pyrene | 2.45 |
| 1,2,4-trimethylbenzene | 2.94 |
| 1,4-difluorobenzene | 1.6 |
| N,N-diethylaniline | 2.96 |
| benzene | 2.17 |
| morpholine | 1.23 |
| chlorobenzene | 2.2 |
| secobarbital | 3.26 |
| 1-naphthol | 2.09 |
| 1-methylethylbenzene | 3.08 |
| 1,5-dimethylnaphthalene | 2.3 |
| cyclohexane | 2.19 |
| lorazepam | 2.51 |
| 1,4-dibromobenzene | 2.97 |
| propylparaben | 2.97 |
| phenolphthalein | 4.56 |
| 5-ethyl-5-heptylbarbituric acid | 3.61 |
| triamcinolone acetonide | 3.51 |
| phenobarbital | 3.31 |
| 3-methylphenol | 2.34 |
| prednisolone-21-acetate | 3.76 |
| 2-naphthol | 2.77 |
| 2-propanol | 0.93 |
| 5-ethyl-5-propylbarbituric acid | 2.19 |
| chlordiazepoxide | 1.36 |
| 1,2,3-trimethylbenzene | 2.26 |
| iodobenzene | 2.9 |
| 4-bromophenol | 2.93 |
| 1,2-benzenediol | 2.04 |
| 1-butanol | 1.32 |
| naphthacene | 3.53 |
| triamcinolone | 3.37 |
| cyclohexanone | 2.71 |
| 1-octanol | 3.29 |
| tetrachloromethane | 2.18 |
| 1-naphthylamine | 3.36 |
| diphenylamine | 3.03 |
| benzo[a]pyrene | 3.34 |
| phenanthrene | 3.18 |
| Cycloheptanol | 3.23 |
| Progesterone | 4.28 |
| 1-pentanol | 1.97 |
| 3-methyl-1-butanol | 2.21 |
| 1,4-dimethylnaphthalene | 2.54 |
| Acenaphthylene | 2.41 |
| 1,4-benzenediol | 2.09 |
| 5-ethyl-5-pentylbarbituric-acid | 3.1 |
| Phenytoin | 2.93 |
| Testosterone | 3.8 |
| 2-methylnaphthalene | 2.85 |
| Indole | 2.26 |
| Cyclohexanol | 2.75 |
| Cyclobarbital | 3.11 |
| 1-hexanol | 2.45 |
| 2-methylphenol | 2.12 |
| Betamethasone | 3.73 |
| betamethasone-17-valerate | 3.32 |
| p-xylene | 2.37 |
| salicylic-acid | 2.63 |
| 2-methyl-2-butanol | 2.02 |
| Acetonitrile | 0.78 |
| Diclofenac | 2.18 |
| Anisole | 2.14 |
| Hexane | 1.78 |
| 1,4-dichlorobenzene | 2.51 |
| 1-adamantanecarboxylic-acid | 5.81 |
| 4-chlorophenol | 2.61 |
| benzaldehyde | 3.23 |
| warfarin | 3.06 |
| benzyl alcohol | 1.7 |
| p-hydroxybenzoic-acid | 3.03 |
| anthracene | 3.41 |
| cyclone plane | 2.87 |
| flurbiprofen | 3.71 |
| 2-octanol | 3.13 |
| hexanoic acid | 2.47 |
| prednisolone | 3.45 |
| thiopental | 3.41 |
| benzophenone | 3.08 |
| cortisone-acetate | 3.62 |
| N,N-dimethylaniline | 2.35 |
| 1,3-benzenediol | 2.04 |
| 2-methylphenol | 2.12 |
| 5,5-diethyl-2-thiobarbituric-acid | 2.47 |
| dexamethasone | 3.67 |
| Cyclooctane | 3.23 |
| fluorobenzene | 1.85 |
| 1-propanol | 0.86 |
| 1-methylnaphthalene | 2.64 |
| 2-pentanol | 1.65 |
| bromobenzene | 2.49 |
| Heptane | 1.84 |
| Cortisone | 3.39 |
| ethylbenzene | 2.52 |
| Acridine | 2.46 |
| Aniline | 1.89 |
| cyclopentane | 1.95 |
| Methanol | −0.4 |
| butylparaben | 3.32 |

Descriptors (Table 3) were generated for geometrically optimized molecules after initial conformational analysis (Merck Molecular Force Field, in Spartan for Windows '04, Wavefunction Inc., Irvine, Calif.) to select conformations close to global minima. Geometry was refined using a semi-empirical MO method, AM1 (HyperChem version 7.52, Hypercube, Gainesville, Fla.). Moments of inertia were also calculated for each optimized structure and ranked from lowest magnitude (I₁) to highest (13). The diameters x₁, x₂ and x₃ of an equivalent ellipsoid were calculated from the moments of inertia (see FIG. 3, and set of Equation (9)). The trained network was applied to another set of neutral compounds (validation set, n=16).

TABLE 3
Starting list of molecular descriptors

| Descriptor | Explanation |
|---|---|
| Eₐₜₒₘ | Energy required to form separated atoms of |
| | given molecule |
| E_{binding} | Energy stabilization due to interatomic bond |
| | formation |
| E_{core} | Energy of non-valence (inner shell) electrons |
| E_{elect} | Energy due to exchange of valence electrons |
| | Eₐₜₒₘ − (E_{binding} + E_{core}) |
| Hf | Heat of formation |
| Dipole | Molecular dipole moment (Debye units) |
| HOMO | Energy of highest occupied molecular orbital |
| LUMO | Energy of lowest unoccupied molecular orbital |
| Max+ | Maximum atomic charge (positive) |
| Max− | Maximum atomic charge (negative) |
| Sum+ | Sum of positive atomic charges |
| | (Sum⁺= −Sum⁻) |
| Tetra | Number of tetrahedral atomic centers (sp3) |
| Planar | Number of planar atomic centers (sp2) |
| Linear | Number of linear atomic centers (sp) |
| Nacc | Number of hydrogen bonding acceptors |
| Ndon | Number of hydrogen bonding donors |
| I₁ | Moment of inertia about principal inertial axis |
| | (x₁) |
| I₂ | Moment of inertia about minor inertial axis (x₂) |
| I₃ | Moment of inertia about shortest minor inertial |
| | axis (x₃) |
| I₁*I₂ | Product of I₁ and I₂ |
| I₂*I₃ | Product of I₂ and I₃ |
| I₁*I₃ | Product of I₁ and I₃ |
| x₁ | Diameter of equivalent ellipsoid along principal |
| | inertial axis |
| x₂ | Diameter of equivalent ellipsoid along minor |
| | inertial axis |
| x₃ | Diameter of equivalent ellipsoid along shortest |
| | minor inertial axis |
| Log P | Calculated logarithm of octanol-water coefficient |
| Ref | Calculated molar refractivity |
| Pol | Calculated molar polarizability |
| SA | Molecular surface area (CDK) |
| Vol | Molecular volume (CDK) |
| Mass | Molecular weight |

Table 4 lists the compounds comprising the validation set. A model reduction method (“holdout”) was applied in which each descriptor was sequentially excluded, with removal of the descriptor affording the largest improvement in correlation between predicted values and measured values for the validation set.

TABLE 4
List of compounds in validation set

| Compound | Log K(1:1) |
|---|---|
| ethyl-p-aminobenzoate | 2.69 |
| Diazepam | 2.2 |
| Hydroquinone | 2.09 |
| 2,2-dimethylpropanol | 2.69 |
| Naphthalene | 2.87 |
| dexamethasone-21-acetate | 3.98 |
| Fluorine | 3.13 |
| Morphine | 1.49 |
| 1,3,5-trimethylbenzene | 1.78 |
| Hydrocortisone | 3.46 |
| 2-methylbutanol | 2.08 |
| Ephedrine | 2.25 |
| Oxazepam | 2.23 |
| benzoic acid | 2.84 |
| Ethanol | −0.05 |
| Acetaminophen | 2.03 |
| glyceryl triacetate | 1.15 |
| 1-aminoadamantane | 5.04 |
| Phenacetin | 2.25 |
| Phenol | 1.96 |
| cinnamic acid | 2.57 |
| 2-butanol | 1.28 |
| acetylsalicylic acid | 3.23 |
| hydrocortisone-21-acetate | 3.51 |
| Cyclooctanol | 3.3 |
| 3-methylphenol | 2.34 |
| decanoic acid | 3.97 |
| Toluene | 2.15 |
| p-toluic acid | 3.23 |
| Acenaphthene | 2.01 |
| 3,3-dimethyl-2-butanol | 2.75 |

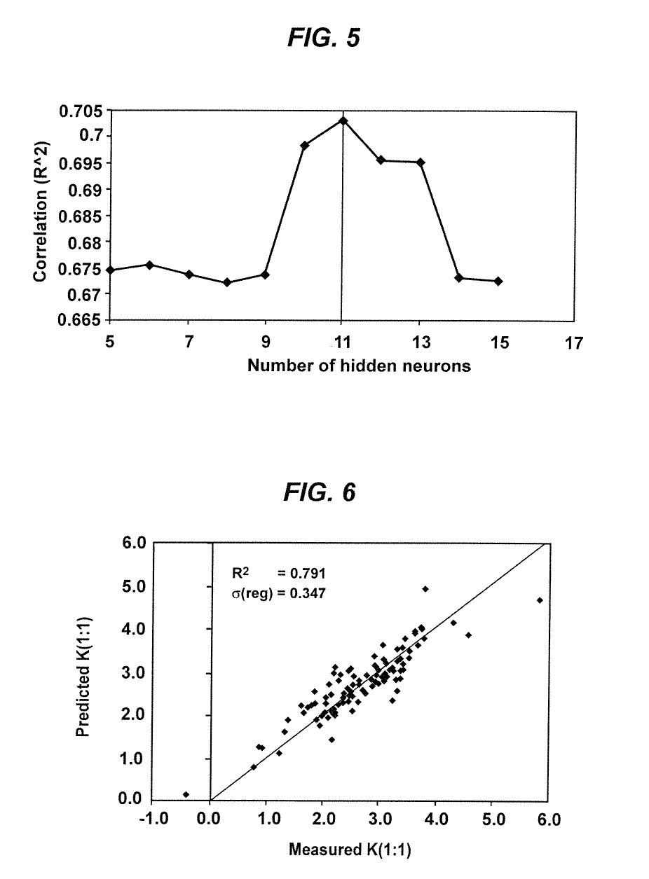

In FIG. 4, correlation (r²) is plotted against the descriptor discarded from each reduced set. After the final descriptor set was obtained, the number of hidden layer neurons in the neural network was optimized by varying the number to maximize correlation in the validation set (see FIG. 5). Application of the final network to a third data set (cross-validation set, n=16), with data not included in the training and validation sets (see Table 5), tested generalization of the reduced model.

TABLE 5
List of compounds in cross-validation set

| | Log K(1:1) | | |
|---|---|---|---|
| Compound | Measured | Predicted | Reference |
| naproxen | 3.20 | 3.55 | Chen et al, 2004 |
| indomethacin | 2.72 | 2.03 | Hamada, et al., 1975 |
| clonazepam | 1.9 | 1.29 | Uekama et al., 1983 |
| ephedrine | 2.25 | 2.89 | Ndou, et al. 1993 |
| benzidine | 3.36 | 3.05 | Uekama et al., 1983 |
| acetone | 0.7 | 0.59 | Tataszewska, 1991 |
| amobarbital | 3.11 | 3.15 | Otagiri, et al., 1976 |
| 1-bicyclo[2.2.1] | 4.18 | 4.33 | Eftink, et al., 1989 |
| heptanecarboxylic acid | | | |
| carbamazepine | 2.83 | 3.46 | Average of 3 values |
| | | | (Al-Meshal, et al., 1993; |
| | | | Nagarenker and Bhave, 1998; |
| | | | Choudhury and Nelson, 1992). |
| 4-aminobenzoic acid | 2.70 | 2.84 | Harata, 1981 |
| chlordiazepoxide | 1.36 | 1.94 | Uekama et al., 1983 |
| clobazam | 1.73 | 1.65 | Nakai, et al., 1990; |
| | | | Uekama et al., 1983 |
| cyclobutanol | 1.18 | 1.18 | Matsui and Mochida, 1979 |
| 1,4 diiodobenzene | 3.18 | 4.21 | Takuma, et al., 1991 |
| 3-hydroxybenzoic acid | 2.46 | 2.27 | Harata, 1981 |
| 4-hydroxybenzoic acid | 3.03 | 2.57 | Harata, 1981; Cai et |
| | | | al., 1990 |

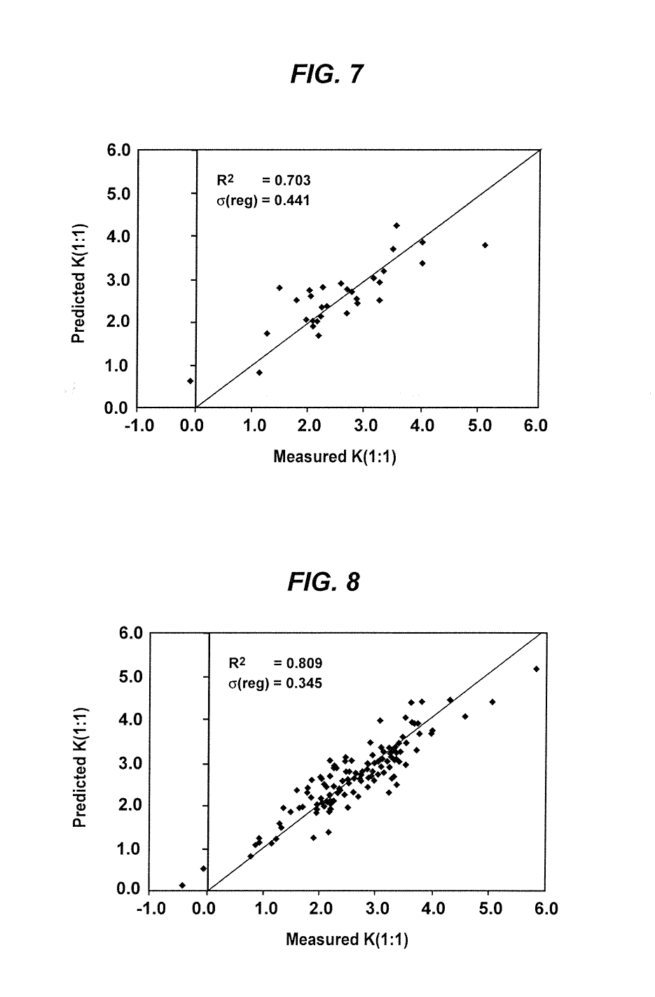

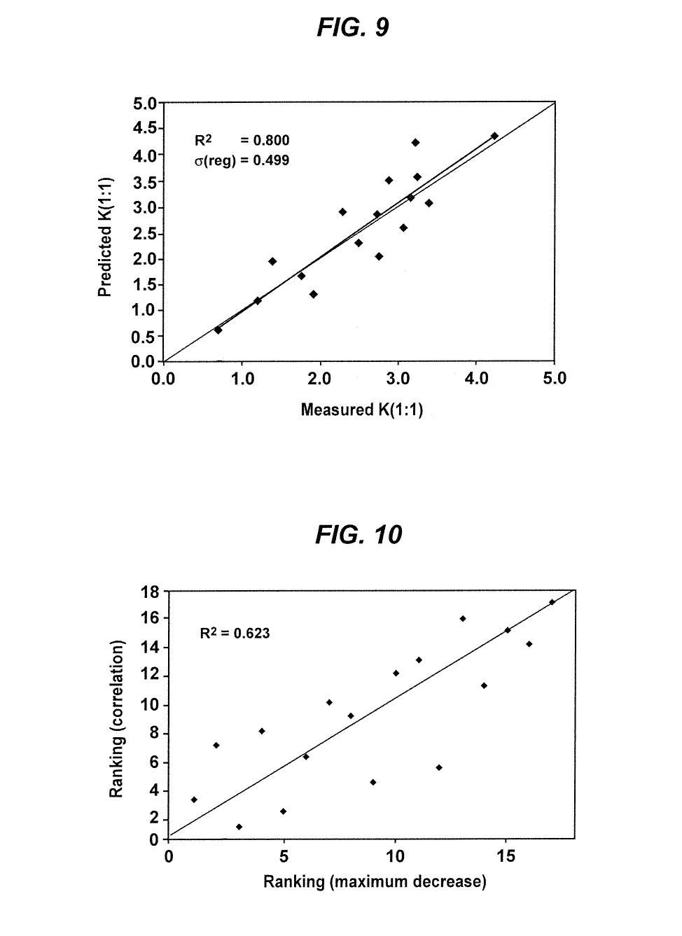

Results of the parameter selection approach are illustrated in FIG. 4. Each point in the plot represents the correlation (r²) after stepwise removal of the corresponding descriptor shown at the bottom. All 31 descriptors were initially used in the network. The vertical line in FIG. 4 denotes the maximum correlation that corresponded to the final set of 17 descriptors. The effect of the number of hidden layer neurons on correlation in the validation set is graphed in FIG. 5, with a maximum occurring at 11 neurons (vertical line). A correlation plot resulting from application of the reduced (17-parameter, 11-hidden neuron) model to the training set is shown in FIG. 6. The diagonal line in this graph and in FIGS. 7, 8, 9 and 10 is a plot of y=x. The correlation plot for the validation set is shown in FIG. 7. FIG. 8 shows the results from application of the finalized neural network to the pooled data (training+validation sets). The optimized network then was used to estimate the binding constants (1:1) for another set of 16 small organic molecules (cross-validation set). Results in FIG. 9 illustrate the near perfect coincidence of the linear regression line (r²=0.80) to line y=x, indicating that the model extrapolates, or generalizes, well to data outside the training set.

Descriptors in the final reduced model are listed in Table 6.

TABLE 6
Reduced descriptor set with parameter ranking

| Method 1 | | | Method 2 | | |
|---|---|---|---|---|---|
| | Number of | | | Correlation | |
| Descriptor | repeats | Rank | Descriptor | (r²) | Rank |
| I3 | 8 | 1 | Log P | 0.4930 | 3 |
| I2*I3 | 3 | 2 | I2 | 0.4963 | 7 |
| Log P | 2 | 3 | I1 | 0.5286 | 1 |
| Mass | 2 | 4 | I1*I2 | 0.5465 | 8 |
| Eₐₜₒₘ | 1 | 5 | I2*I3 | 0.5520 | 2 |
| Dipole | 1 | 6 | Dipole | 0.5597 | 6 |
| I2 | 1 | 7 | Vol | 0.6090 | 10 |
| I1*I2 | 1 | 8 | x2 | 0.6092 | 9 |
| x2 | 1 | 9 | Mass | 0.6114 | 4 |
| Vol | 1 | 10 | E_{core} | 0.6192 | 12 |
| E_{binding} | 0 | 11 | E_{elect} | 0.6192 | 13 |
| E_{core} | 0 | 12 | Eₐₜₒₘ | 0.6192 | 5 |
| E_{elect} | 0 | 13 | ndon | 0.6194 | 16 |
| HOMO | 0 | 14 | E_{binding} | 0.6195 | 11 |
| Tetra | 0 | 15 | Tetra | 0.6517 | 15 |
| Ndon | 0 | 16 | HOMO | 0.6584 | 14 |
| Pol | 0 | 17 | Pol | 0.6810 | 17 |

These Table 6 descriptors are ranked in importance using two methods: (1) the number of times that removal of a parameter resulted in the largest lowering in correlation with the validation set, and (2) correlation ranking (lowest to highest) for parameter exclusion from the final reduced model. Correlation between rank ordering determined by method 2 versus method 1 is shown in FIG. 10. The most important 10 descriptors (underlined in Table 6) are common to both ranking methods with the exception of Ecore and Eatom. It is to be noted that both sets of the ten most important descriptors contained the inertial moments 12 and 13 and all cross-products except I₁I₃.

Molecular inertial moments correspond to rotation about respective inertial axes (see FIG. 3). I₃ (largest moment) is related to the torque needed to rotate the molecule about its shortest inertial axis, x₃. This parameter should be most closely related to the ellipsoidicity (elongation) of the molecule along its principal axis (x₁). The smallest moment of inertia, I₁, resulting from rotation about the principal (major) inertial axis, conveys little information about ellipsoidicity. The importance of the I₂ and I₃ descriptors, in conjunction with molecular mass reflects the relationship to molecular topology (size and shape), directly impacting the ability of the molecule to fit within the cyclodextrin cavity.

The following references and all other patents, publications and references identified herein are hereby incorporated by reference hereinto.
1. Al-Meshal, M. A.; El-Mahrook, M.; Al-Angary, A. A.; Gouda, M. W. Pharm. Ind., 1993, 55(12), 1129-1132)
2. Becke, A. D. A new mixing of Hartree-Fock and local density-functional theories, J. Chem. Phys. 98, 1372-1377 (1993).
3. Bodor, N.; Gabanyi, Z.; Wong, C. J. Am. Chem. Soc., 111, 3783 (1989).
4. Cai, Y.; Gaffney, S. H.; Lilley, T. H.; Magnolato, D.; Martin, R.; Spencer, C. M.; Haslam, E. J. Chem. Soc., Perkin Trans. 2 1990, 2197.
5. Chen, W. et al, Biophysical Journal, 2004, 87, 3035-3049.
6. Connors, K. J. Pharm. Sci., 84, 843-848 (1995).
7. Eftink, M. R.; Andy, M. L.; Byström, K.; Perlmutter, H. D.; Kristol, D. S. J. Am. Chem. Soc. 1989, 111, 6765.
8. Fausett, L. Fundamentals of Neural Networks: Architectures, Algorithms, and Applications, Prentice-Hall, Upper Saddle River N.J., 1994.
9. Gavezotti, A. J. Am. Chem. Soc., 10, 5220 (1983).
10. Ghose, A. K.; Crippen, G. M. J. Chem. Inf. Comput. Sci., 27, 21 (1987)
11. Ghose, A. K.; Pritchett, A.; and Crippen, G. M. J. Comp. Chem., 9, 80 (1988)
12. Hamada, H.; Nambu, N.; Nagai, T. Chem. Pharm. Bull. 1975, 23, 1205.
13. Harata, K. Bioorg. Chem. 1981, 10, 255.
14. Hehre W. J. A Guide to Molecular Mechanics and Quantum Chemical Calculations, Wavefunction, Irvine Calif., 2003, p 436
15. Matsui, Y.; Mochida, K. Bull. Chem. Soc. Jpn. 1979, 52, 2808.
16. Miller, K. J. J. Am. Chem. Soc., 112, 8533 (1990).
17. Nakai, Y.; Aboutaleb, A. E.; Yamamoto, K.; Saleh, S. I.; Ahmed, M. O. Chem. Pharm. Bull. 1990, 38, 728.
18. Ndou, T. T.; Mukundan, S., Jr.; Warner, I. M. J. Inclusion Phenom. 1993, 15, 9.
19. Nelder, J. A. and Mead, R. “A Simplex Method for Function Minimization.” Comput. J. 1965, 7, 308-313.
20. Otagiri, M.; Miyaji, T.; Uekama, K.; Ikeda, K. Chem. Pharm. Bull. 1976, 24, 1146.
21. Robins, R. K. J. Chem. Inf. Comput. Sci., 29, 163 (1989).
22. Takuma, T.; Deguchi, T.; Sanemasa, I. Bull. Chem. Soc. Jpn. 1991, 64, 480.
23. Taraszewska, J. J. Inclusion Phenom. 1991, 10, 69.
24. Uekama, K.; Narisawa, S.; Hirayam, F.; Otagiri, M. Int. J. Pharm. 1983, 16, 327.
25. Viswanadhan, V. N.; Ghose, A. K.; Revankar, R. K.; Robins, R. K. J. Chem. Inf. Comput. Sci., 29, 163 (1989).

It will be understood that the embodiments of the present invention which have been described are illustrative of some of the applications of the principles of the present invention. Numerous modifications may be made by those skilled in the art without departing from the true spirit and scope of the invention. Various features which are described herein can be used in any combination and are not limited to procure combinations that are specifically outlined herein.

What is claimed is:

1. A computational method that comprises a feed-forward, back-propagation neural network and associated algorithms for estimating the equilibrium between a guest and host compound pair and the inclusion (guest-host) complex that is formed by their interaction.

2. The computational method of claim 1 wherein the inclusion complex is formed by mixing a compound with a cyclodextrin, said compound having a water solubility less than 10 mg/mL, to afford an aqueous solution.

3. The computational method of claim 2 wherein the cyclodextrin is beta-cyclodextrin.

4. The computational method of claim 2 wherein the cyclodextrin is alpha-cyclodextrin.

5. The computational method of claim 2 wherein the cyclodextrin is gamma-cyclodextrin.

6. The computational method of claim 2 wherein the cyclodextrin is a derivative of beta-cyclodextrin

7. The computational method of claim 2 wherein the cyclodextrin is a derivative of alpha-cyclodextrin.

8. The computational method of claim 2 wherein the cyclodextrin is a derivative of gamma-cyclodextrin.

9. The computational method of claim 6 wherein the cyclodextrin derivative is 2-hydroxypropyl-beta-cyclodextrin.

10. The computational method of claim 6 wherein the cyclodextrin derivative is sulfobutylether 7-beta-cyclodextrin.

11. The computational method of claim 1 wherein some or all of input parameters to the neural network are molecular parameters derived by application of quantum mechanical computations.

12. The computational method of claim 1 wherein some or all of input parameters to the neural network are molecular parameters derived by application of molecular mechanical computations.

13. The computational method of claim 1 wherein some or all of input parameters to the neural network are molecular parameters derived by application of group contribution computations.

14. The computational method of claim 1 wherein the associated algorithms enable network optimization by reducing the number of input parameters, this reduction carried out by stepwise exclusion of one or more parameters followed by a statistical fit measurement of the values predicted by the network and the measured values of an external validation set that is not included in the data set used to train the network.

15. The computational method of claim 14 wherein the statistical fit measurement comprises a correlation analysis using said values.

16. The computational method of claim 14 wherein the statistical fit measurement comprises a sum of absolute differences using said values.

17. The computational method of claim 14 wherein the statistical fit measurement comprises a sum of squared differences using said values.

18. The computational method of claim 14 wherein the statistical fit measurement comprises a standard deviation using said values.

19. The computational method of claim 1 wherein the associated algorithms enable network optimization by varying the number of hidden layer neurons of the network and subsequently performing a correlation analysis between predicted values and measured values in an external validation set that is not included in the set of data used to train the network.

20. The computational method of claim 1 wherein the associated algorithms enable network optimization by varying the number of hidden layers of the network and subsequently performing a correlation analysis between predicted values and measured values in an external validation set that is not included in the set of data used to train the network.

21. A computational method in which at least one input parameter is a molecular moment of inertia about an inertial axis, or function thereof.

22. A composition comprising a guest-host complex formed by interaction between a guest compound, said guest compound being a pharmaceutical, and a host compound, said host compound being a cyclodextrin, said host compound having been selected for the specific guest compound by neural network analysis of molecular parameters.
